(19) United States
(12) Patent Application Publication
(10) Pub. No.: US 2025/0077937 A1
(43) Pub. Date: Mar. 6, 2025

(54) EVALUATING MACHINE LEARNING (ML)-GENERATED PERSONALIZED RECOMMENDATIONS USING SHAPLEY ADDITIVE EXPLANATIONS (SHAP) VALUES

(71) Applicant: Intuit, Inc., Mountain View, CA (US)

(72) Inventors: Jingyuan ZHANG, San Jose, CA (US); Shankar SANKARARAMAN, Burlingame, CA (US)

(21) Appl. No.: 18/239,709

(22) Filed: Aug. 29, 2023

(51) Int. Cl. G06N 20/00

(52) U.S. Cl. CPC G06N 20/00

(57) ABSTRACT

Certain aspects of the present disclosure provide techniques for selecting between a model output of a machine learning (ML) model and a generic output. A method generally includes processing user-specific data with the ML model to generate the model output and a model predicted score associated with the model output; calculating a Shapley Additive Explanations (SHAP) score based on the model output, the model predicted score, and the user-specific data; and providing the model output or the generic output as output from the ML model based on the SHAP score.

### INTRODUCTION

Aspects of the present disclosure relate to machine learning (ML)-based recommender systems, and in particular to, an ML-based recommender system configured to use Shapley Additive Explanations (SHAP) values to select the most effective output between a predicted model output (e.g., a personalized recommendation) or a generic output (e.g., a non-personalized recommendation).

### BACKGROUND

All around the world, the internet continues to transform how individuals connect with others and share information. With its growing influence on individuals and large economies alike, the internet has become a vital part of people's everyday lives. While the number of internet users continue to grow year-over-year, so does the volume of information made available online. In fact, according to latest estimates (2023), about 300 million terabytes of data are created each day. While there are major benefits to sharing information over the Internet, including an ability to reach a wider audience, the explosive growth in the amount of available information has created an information overload problem for online users.

Information overload is a state of being overwhelmed by the amount of data presented for one's attention and/or processing. The term is used to refer not only to situations involving too much data for a given decision but also the constant inundation of data from many sources. Information overload reduces an online user's capacity to function effectively, which can lead to poor decision making and/or an inability to make decisions, as well hinders timely access to items of interest on the Internet.

A strategy for preventing information overload is intentionally limiting the amount of online information exposure by being selective about the type and/or amount of data presented to users over the Internet. Recommender systems (also referred to as “recommender engines”) are example information filtering systems that help to limit the amount of online information exposure. In particular, recommender systems are able to provide recommendations in real-time.

There are two main types of recommender systems: non-personalized and personalized. As the name suggests, non-personalized recommender systems provide general recommendations to online users without any context of what these users want and/or their preferences. For example, when a user visits a website for an online retailer, the website may provide the user with a list of the ten most popular (e.g., highest product rating) items. In particular, a non-personalized recommender system associated with the website may calculate a mean product rating for all products sold online (or in some cases, for products sold online in a particular geographic location, for a particular age group, or the like). Only the ten products having a highest mean product rating may be displayed to the user via the website, thereby limiting the amount of content displayed on the website. Because the products displayed to a user are not based on the particular user's data, the recommendations are considered to be non-personalized. Personalized recommender systems, on the other hand, may leverage machine learning (ML) algorithms and techniques to give the most relevant suggestions to a particular user by learning data (e.g., past interests, past preferences, relationships, past behavior with content, a product, a website, an application, and/or a service, etc.) and predicting current interests and preferences. In this way, every user receives a customized recommendation, also referred to herein as a personalized recommendation.

As powerful personalization tools, personalized recommender systems are beneficial to both service providers and users. For example, personalized recommender systems help to reduce transaction costs of finding and/or selecting items in an online shopping environment. Personalized recommender systems help to improve decision making processes. In e-commerce settings, personalized recommender systems help to increase company revenues, for example, in cases where the recommender systems are effective in means of selling more products. Further, in some cases, personalized recommender systems help user discover items they might not have found otherwise.

Two main approaches to building recommender systems include (1) content-based filtering and (2) collaborative filtering. Content-based filtering recommender systems provide recommendations using specific attributes of items by finding similarities. Such systems create data profiles relying on description information that may include characteristics of items or users. Then the created profiles are used to recommend items similar to those the user liked/bought/watched/listened to in the past. Thus, a key aspect of content-based filtering recommender systems is the assumption that if users liked some items in the past, they may like similar items in the future.

Collaborative filtering recommender systems provide relevant recommendations based on interactions of different users with target items. Such recommender systems gather past user behavior information and then mine it to decide which items to display to other active users with similar tastes. This can be anything from songs users listened to or products they added to a cart to ads users clicked on and/or movies they previously rated. The idea of such a system is to try to predict how a person would react to items that they have not interacted with yet.

Despite the success of these two types of recommender systems, performance of both systems are subject to certain limitations. For example, one problem associated with content-based filtering techniques includes overspecialization that often results in these recommender systems recommending only items that are very similar to those that have been rated or seen by a user before. In other words, content-based recommender systems may be limited to only those items a user has previously consumed, and thus may not be able to reveal anything surprising or unexpected. Further, a major problem limiting the usefulness of collaborative filtering recommender systems is the sparsity problem, which refers to a situation in which data is sparse and/or insufficient to identify similarities in user interests. The cold-start problem, which describes the difficulty of making recommendations when the users or the items to be recommended are new, is also a challenge present in collaborative filtering recommender systems.

Such problems associated with personalized recommender systems tend to reduce the quality of personalized recommendations predicted by the model, and thus, further reduce the overall effectiveness of the personalized recommendation when provided to the user. As used herein, an effective personalized recommendation (also referred to herein as an “effective recommendation”) is a prediction, personalized for a user, which is successful in producing a desired result. The desired result may include interaction with the recommendation (e.g., such as viewing, clicking on, and/or selecting the recommendation), positive feedback provided for the recommendation (e.g., a five star rating indicated for the recommendation), a purchase associated with the recommendation, and/or the like. For example, in a recommender system designed to provide movie recommendations to a user, an effective recommendation may be a movie predicted by the system for the user that is later watched by the user. An ineffective recommendation may be a movie recommendation provided by the user that was never watched by the user and/or at a later time poorly rated by the user. In some cases, the effectiveness of a personalized recommendations may also be measured by metrics such as, for example, click-through rates, conversion rates, and/or user engagement (e.g., based on direct and/or indirect interactions of a user with a personalized recommendation).

Due to the limitations of personalized recommender systems, as described above, ineffective recommendations produced by these systems may be inevitable. Ineffective predictions (e.g., generated due to data sparsity problems, cold-start problems, etc.) provide misleading recommendations to a user thereby reducing overall performance of the recommender system. Further, ineffective recommendations provided by the system to a user may adversely impact the user's trust and acceptance of the recommender system.

Accordingly, what is needed are techniques for identifying and mitigating the impact of ineffective recommendations predicted by a personalized recommender system, as well as techniques for improving model performance in these personalized recommender systems to reduce a number of ineffective recommendations predicted by models in these systems.

### SUMMARY

One embodiment provides a method for selecting between a model output of a machine learning (ML) model and a generic output, including processing user-specific data with the ML model to generate the model output and a model predicted score associated with the model output; calculating a Shapley Additive Explanations (SHAP) score based on the model output, the model predicted score, and the user-specific data; and providing the model output or the generic output as output from the ML model based on the SHAP score.

Another embodiment provides a method for training an ML model to generate effective model output including processing user-specific data with the ML model to generate a model output and a model predicted score associated with the model output; calculating a Shapley Additive Explanations (SHAP) score based on the model output, the model predicted score, and the user-specific data; determining the SHAP score associated with the model output is equal to or above a threshold value; providing the model output as output from the ML model based on the SHAP score being equal to or above the threshold value; obtaining negative feedback indicating that the model output is an ineffective recommendation; creating a training data instance comprising: a training input comprising the user-specific data; and a training output comprising the model output and an indication that the model output is associated with the negative feedback; and adjusting one or more parameters of the ML model based on the training data instance.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The appended figures depict certain aspects of the one or more embodiments and are therefore not to be considered limiting of the scope of this disclosure.

FIG. 1 illustrates an example ML-based, personalized recommender system configured to evaluate personalized recommendations generated by the system prior to providing a recommendation to a user of the system.

FIG. 2 illustrates an example method for selecting between a model output (e.g., a personalized recommendation) and a generic output (e.g., a non-personalized recommendation).

FIG. 3 illustrates an example process for measuring the effectiveness of a personalized recommendation generated by an ML-based, personalized recommender system.

FIG. 4 illustrates an example relationship between a Shapley Additive Explanations (SHAP) score calculated for a model output of an ML model belonging to a personalized recommender system and a model prediction score and a base SHAP value associated with the model output.

FIGS. 5A and 5B together illustrate improved model performance when Shapley Additive Explanations (SHAP) values are used to select between a model output (e.g., a personalized recommendation) and a generic output (e.g., a non-personalized recommendation).

FIG. 6 illustrates an example processing system on which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Determining the effectiveness of personalized recommendations generated by ML models (e.g., as used in ML-based personalized recommender systems) is a technically challenging problem. For example, it is technically challenging to accurately distinguish effective personalized recommendations from ineffective personalized recommendations according to a repeatable, objective method. This technical challenge is in-part because the number of possible inputs to a model as well as the number of possible outputs (e.g., personalized recommendations) from the model used by a recommender system (referred to herein as “recommendation candidates”) may be vast, and, consequently, testing each of these possibilities is impractical. Thus, creating a methodology that effectively and accurately predicts the effectiveness of each possible recommendation candidate against another recommendation candidate (e.g., for purposes of providing a most effective recommendation to a user) is a technically difficult and daunting task. Historically, the relative effectiveness of one recommendation compared to another might only be addressed subjectively across a small subset of the set of possible recommendations, and thus confidence of the overall system was difficult to measure and improve. Moreover, pairwise comparison of different recommendations to determine which is most effective is a classically compute-intensive operation that requires significant compute resources, time, and resource expenditure.

For example, an online retailer, may have millions of unique stock keeping unit (SKU) numbers associated with different products sold by the online retailer. Thus, personalized recommendations generated by a recommender system created for this online retailer (e.g., for purposes of determining what products to display to each user of their website) may include any one of the millions of SKU numbers associated with the retailer's products. Creating a methodology that objectively predicts the effectiveness of recommending one SKU versus another SKU, such that a most effective recommendation is determined (e.g., recommending the SKU the user will find most appealing) is a technically challenging task given the number of possible recommendations and the varying preferences of individual users. This becomes even more challenging where the number of personalized recommendations that may be generated by the recommender system changes over time. For example, the set of SKUs offered by the retailer may change frequently; thus, the effectiveness pairwise comparison of recommendations may need to be re-evaluated continuously, leading to exorbitant resource usage.

Existing techniques for measuring the effectiveness of personalized recommendations have focused on online experiments, such as A/B tests, which involve providing different recommendations to different sets of users and seeing which leads to the more desired outcome. Further, users may be queried later to understand why one of the two options was more effective than the other. However, these experiments are generally costly, time-consuming, subjective, and fail to cover the broad range of possible recommendations and users. In particular, user feedback may be a poor mechanism for understanding the effectiveness of each recommendation candidate of a recommender system.

Accordingly, there is a need for a technical solution for measuring the effectiveness of a personalized recommendation generated by a recommender system against another recommendation. For example, a personalized recommendation may be measured against an alternative or “generic” recommendation and the more effective recommendation between these two may be provided as output of a recommender system. Avoiding providing ineffective personal recommendations beneficially improves overall performance of the recommender system.

Embodiments described herein overcome the aforementioned technical problems and improve upon the state of the art by providing a recommender system configured to objectively measure the effectiveness of a personalized recommendation (e.g., generated by an ML model based on user data) versus a generic recommendation (e.g., generated by the ML model using generic, non-user data) using Shapley Additive Explanations (SHAP) values. Generally, SHAP values provide a way to explain the output of an ML model by providing an objective measure of how each input feature of the ML model impacts the model's corresponding output. In particular, SHAP values assign an importance value to each input feature of the ML model. Features with positive SHAP values positively impact the prediction, while those with negative values have a negative impact. The magnitude of each feature-specific SHAP value (e.g., per feature) is a measure of how strong of an effect the feature has on the model's output. SHAP values are additive, which means that the contribution of each feature to the final prediction can be computed independently and then summed up to give an overall SHAP value (referred to herein as a “SHAP score”) for a set of input features.

A user-specific output may be generated by providing user-specific input feature data to an ML model to generate the user-specific output (also referred to herein as “model output”), such as a personalized recommendation. A generic output, on the other hand, may be generated by providing generic input data (e.g., a vector of all zero values, or all random values) to the ML model to generate the generic output, such as a generic recommendation.

A SHAP score for the personalized recommendation can be calculated as an aggregate of SHAP values determined for each input feature in the user-specific data processed by the ML model to generate the model output. The calculated SHAP score takes into account the contribution of each input feature in the user-specific data in generating the model output. A high first score may indicate that the input features in the user-specific data had a significant impact in generating the model output; thus, there is a high chance that the model output comprises an effective recommendation. Alternatively, a low first score may indicate that the input features in the user-specific data did not have a significant impact in generating the model output; thus, there is a low chance that the model output comprises an effective recommendation.

In some embodiments, the SHAP score is then compared to a threshold value to determine whether the personalized recommendation is (1) an effective recommendation, and thus should be provided as output to a user, or (2) an ineffective recommendation, and thus the generic recommendation should be provided as output to the user. For example, if the SHAP score is below the threshold, the model output predicted by the ML model is determined to be ineffective and the generic recommendation is used, whereas, if the SHAP score is above the threshold, the model output predicted by the ML model is determined to be effective and the personalized recommendation is used. Thus, calculating and comparing SHAP scores for personalized recommendations (e.g., model output) against a threshold provides an objective, numeric, and repeatable approach for measuring the effectiveness of personalized recommendations and selecting the best recommendation for a user (e.g., selected between a personalized recommendation and a generic recommendation).

The system described herein thus provides significant technical advantages over conventional solutions, such as an ability to measure the effectiveness of ML-generated recommendations. These systems overcome the aforementioned technical problems and provide the beneficial technical effect of objectively and reliably measuring the effectiveness of personalized recommendations generated by a ML model. Measuring the effectiveness of model output (e.g., personalized recommendations) improves the recommender system as a whole to provide more consistently effective recommendations.

### Example Recommender System Configured to Use SHAP Values to Select Between Providing a Personalized Recommendation or a Generic Recommendation

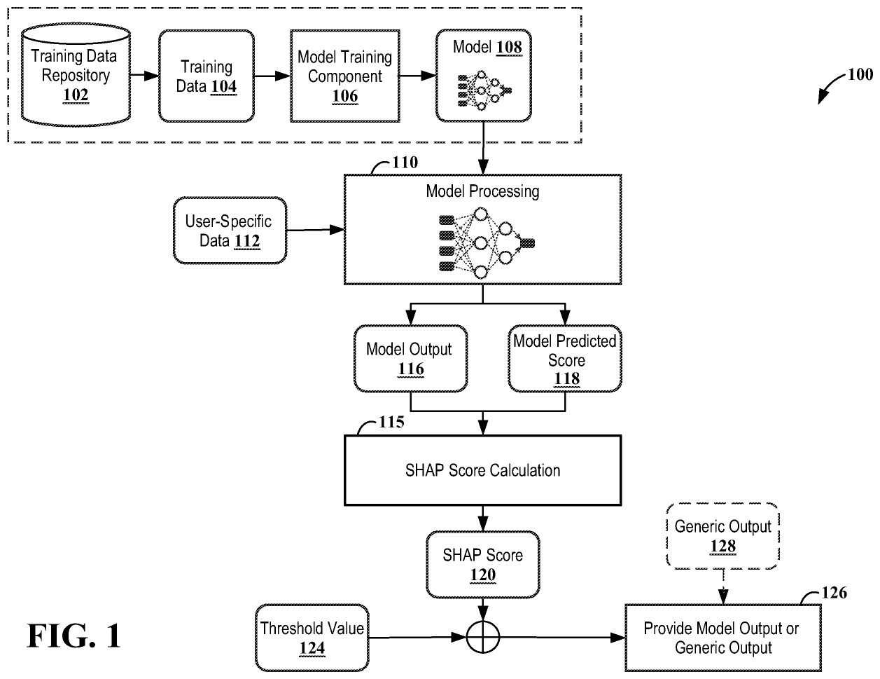

FIG. 1 illustrates an example recommender system 100 (simply referred to herein as “system 100”) configured to evaluate the effectiveness of personalized recommendations prior to providing recommendations to a user of system 100. Recommendations provided by system 100 to a user are generally one of (1) personalized recommendations that are determined to be effective recommendations for the user or (2) generic recommendations (e.g., non-personalized recommendations) when personalized recommendations generated by system 100 are determined to be ineffective. As described in more detail below, system 100 uses SHAP values in various embodiments to determine the effectiveness of such personalized recommendations to determine when personalized versus generic recommendations should be provided to the user.

To generate a personalized recommendation for a user and further select between providing the personalized recommendation or a generic recommendation, system 100 begins with processing, by a model 108 at step 110 in FIG. 1, user-specific data 112 to thereby generate a model output 116 (e.g., a personalized recommendation) and a model predicted score 118 (e.g., f(x) where x is the user specific data 112). Depending on model type of model 108, model output may represent one class/recommendation among a set of possible classes/recommendations.

Model 108 is a personalized recommendation model. More specifically, model 108 is an ML model trained to make personalized recommendations for a user based on user-specific data 112 provided to model 108. User-specific data 112 may provide information about the user's interests, preferences, relationships, and/or past behavior with content, a product, a website, an application, and/or a service, to a name a few personalized recommendations generated by model 108 which may take various forms. For example, personalized recommendations generated by model 108 may include a recommendation to display a particular product to a user browsing on an online retailer's website, a recommendation to play a particular song for listening by a user, a recommendation to display a movie icon related to a particular movie on a streaming platform that a user has a subscription to, and/or the like. As another example, personalized recommendations generated by model 108 may include a recommended tax product among multiple tax products, each having their own complexities, which a user is recommended to use for tax filing purposes. An effective recommendation of a tax product may help the user to accurately and efficiently file their taxes, while helping to minimize their tax liability.

In some embodiments, model 108 is a tree-based model such as, for example, eXtreme gradient boosting (XGBoost) or light gradient-boosting machine (LightGBM). In some embodiments, model 108 is a deep learning model.

In FIG. 1, model output 116 generated by model 108 processing user-specific data 112 is a predicted output among a set of possible predicted outputs of model 108 (for example, across classes where model 108 has a SoftMax layer, or other similar layer). In some cases, the model output is determined based on a highest probability of a particular output (e.g., a classification), or by using a thresholding approach, or other similar approaches. For example, model 108 may be configured to generate model predicted scores 118 (e.g., probabilities or other scores) associated with multiple predicted outputs (e.g., multiple different recommendations) based on processing user-specific data 112.

In some embodiments, model 108 is configured to use thresholding techniques to select a single predicted output from the set of possible predicted outputs. Thresholding refers to a technique for setting (e.g., configuring) a selection threshold and using this selection threshold to determine a predicted output from a set of possible predicted outputs of model 108. In particular, as described above, each possible predicted output may have a model predicted score 118 assigned by model 108, such as probability, likelihood, odds statistic (e.g., indicating a probability of the corresponding predicted output being an effective prediction and a probability of the corresponding predicted output being an ineffective prediction, log odds statistic, or other score). The model predicted score 118 generated for/assigned to each possible predicted output may be compared against the selected threshold. A predicted output among the plurality of predicted outputs having an assigned value above the selection threshold may be selected as the model output 116 of model 108. For example, a model predicted score 118 generated for each possible predicted output of model 108 may be a value indicating a percentage chance that the user would interact with a product associated with the recommendation. In particular, a model predicted score 118 equal to 90% (e.g., indicating a 90% chance) may be assigned to a recommendation to display a dress on a website, a model predicted score 118 equal to 50% may be assigned to a recommendation to display a shoe on the website, and a model predicted score 118 equal to 55% may be assigned to a recommendation to display a jacket on the website. In a case where the selection threshold is set to 85%, the recommendation selected as model output 116, using the thresholding approach, would be the recommendation to display the dress (e.g., associated with the model predicted score 118 equal to 90%, which is greater than the 85% threshold).

Subsequent to generating and selecting model output 116 from a plurality of predicted recommendations generated by model 108, a SHAP score 120 is calculated for model output 116 (e.g., at step 115 in FIG. 1). In some examples, the SHAP score 120 calculated for model output 116 is an aggregate of SHAP values determined for each input feature in user-specific data 112, processed by model 108 to predict model output 116. As above, the SHAP score 120 takes into account the contribution (e.g., positive and/or negative) of each input feature in user-specific data 112 when generating/predicting model output 116. A high SHAP score 120 may indicate that the input features in user-specific data 112 had a significant impact (e.g., positive effect) on model output 116. Thus, model output 116 may have a high probability of being an effective recommendation. The opposite may be true where SHAP score 120 is low.

The SHAP score 120 calculated for model output 116 may be equal to the absolute value of a difference between model predicted score 118 for model output 116 and a base SHAP value for model output 116 (E[f(x)]) (e.g., SHAP score 120=| f(x)−E[f(x)]|). The base SHAP value for model output 116 represents an average model predicted score across an entire observed training dataset. For example, training data 104 used to train model 108 may include ten training data instances. Each training data instance may be fed to model 108 to produce model output 116. Thus, ten model predicted scores may be generated for model output 116. The base SHAP value for model output 116 may be calculated as the average of these ten model predicted scores.

In some cases, the base SHAP value is associated with a least effective recommendation of model 108 given the base SHAP value represents the average prediction across an entire training dataset, instead of data for a particular user. The base SHAP value is generally expected to be less than SHAP score 120 calculated for model output 116; in other words, the SHAP score 120 for user-specific data 112 is generally expected to be higher than the base SHAP value for training data of multiple users.

System 100 proceeds with comparing the SHAP score 120 calculated for model output 116 to a threshold value 124 to determine whether model output 116 is an effective recommendation or an ineffective recommendation generated by model 108. If SHAP score 120 is below threshold value 124, then model output 116 is determined to be an ineffective recommendation. Alternatively, if SHAP score 120 is above threshold value 124, then model output 116 is determined to be an effective recommendation. In other words, threshold value 124 is used as a cut-off in this example for determining whether model output 116 is an effective or an ineffective recommendation, and thereby whether or not it will be provided as output.

At step 126 in FIG. 1, system 100 determines whether to provide model output 116 (e.g., a personalised recommendation) or a generic output 128 (e.g., a non-personalized recommendation) to the user as the output of model 108 based on whether model output 116 is determined to be an effective or an ineffective recommendation. If model output 116 is determined to be an effective recommendation, model output 116 is provided to the user. Alternatively, if model output 116 is determined to an ineffective recommendation, model output 116 is not provided to the user, and instead, generic output 128 is provided in its place. Providing generic output 128 instead of an ineffective recommendation may help to improve system 100 performance, and thus, maintain user trust and acceptance of recommendations provided by system 100. In particular, because an ineffective recommendation may be misleading, by providing a generic output 128 (e.g., a non-personalized recommendation to a user) in place of the ineffective recommendation, system performance may be improved.

The value assigned to threshold value 124 may determine how aggressive model 108 is in classifying model outputs 116 as effective or ineffective recommendations. In particular, a higher threshold value 124 may classify a smaller number of model outputs (e.g., personalized recommendations) as effective recommendations and a larger number of model outputs as ineffective recommendations, thereby leading to a more conservative system 100 that outputs generic output (e.g., non-personalized recommendations) relatively more often.

On the other hand, a lower threshold value 124 may classify a larger number of model outputs (e.g., personalized recommendations) as effective recommendations and a smaller number of model outputs as ineffective recommendations. Generally speaking, threshold value 124 is a tunable parameter that may be set based on preferences regarding the operation of system 100.

In some embodiments, to determine a threshold that will enable the greatest amount of effective recommendations to be provided to users of system 100 without sacrificing performance of system 100 (and its corresponding model 108), interaction of users with model output 116 provided to the users may be monitored. For example, a model output 116 may be a recommendation to display a particular icon to the user. Assuming the model output 116 is determined to be an effective personalized recommendation, model output 116 may be provided to the user by displaying this icon. System 100 may monitor the interaction of the user with the displayed icon to determine whether the model output 116 was accurately determined to be an effective recommendation, based on the current threshold value 124 defined for system 100. Based on system 100 detecting no interaction between the user and the displayed icon, system 100 may determine that threshold value 124 needs to be increased. Increasing threshold value 124 may help to prevent such model output 116 from being classified as an effective personalized recommendation, and thus provided to the user, in future iterations where similar user-specific data 112 is received by model 108 in system 100.

Prior to deployment in system 100, model 108 may be trained by model training component 106. Model training component 106 is generally configured to train models to generate personalized recommendations for various users. In some embodiments, model training component 106 receives training data 104 from training data repository 102, and uses the training data 104 to train model 108. The training data 104 may include a plurality of training inputs including information about user preferences, user interests, and/or past user behavior. The training data 104 may also include a plurality of training outputs corresponding to these training inputs. Each training output may be a recommendation that the user interacted with (e.g., indicating positive feedback) or a recommendation that the user did not interact with (e.g., indicating negative feedback). This training data 104 may be used to train model 108 to generate a model output (e.g., a personalized recommendation) and a first value for the model output.

### Example Method for Selecting Between a Personalized Recommendation and a Non-Personalized Recommendation as Model Output

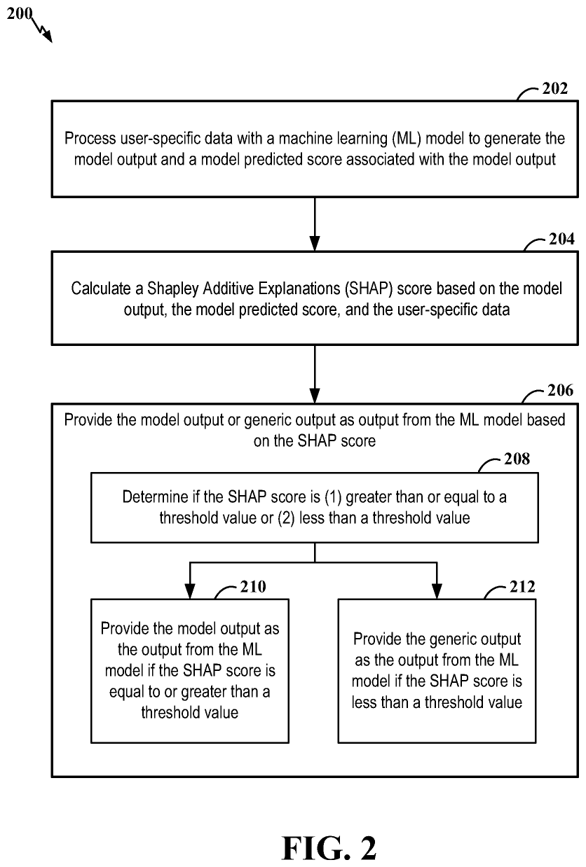

FIG. 2 illustrates an example method 200 for selecting between a model output (e.g., model output 116 in FIG. 1) of an ML model belonging to a personalized recommender system (e.g., model 108 in system 100 illustrated in FIG. 1) and a generic output (e.g., generic output 128 in FIG. 1). The model output and the generic output may correspond to a personalized recommendation and a non-personalized recommendation, respectively.

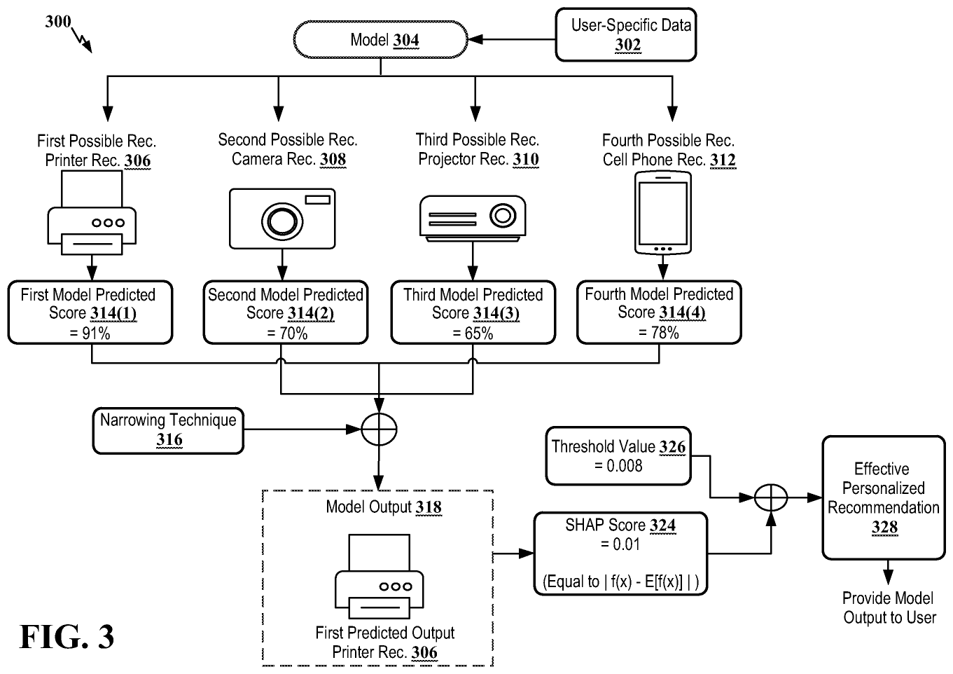

FIG. 3 illustrates an example process 300 for measuring the effectiveness of a personalized recommendation (e.g., model output 116 in FIG. 1) generated by an ML-based, personalized recommender system (e.g., system 100 including model 108 illustrated in FIG. 1). Example process 300 for measuring the effectiveness of the personalized recommender system may be based on example method 200 illustrated in FIG. 2. Accordingly, FIGS. 2 and 3 are described in conjunction below.

In FIG. 2, method 200 begins, at step 202, with processing user-specific data (e.g., user-specific data 112 in FIG. 1) with an ML model (e.g., model 108 in FIG. 1) to generate a model output (e.g., model output 116 of FIG. 1) and a model predicted score (e.g., model predicted score 118 in FIG. 1) associated with the model output. The model predicted score generated may be calculated as f(x) where x is the input vector of values associated with input features provided to the ML model for processing and predicting the model output. In some embodiments, the model output generated by the ML model comprises a predicted output among a set of possible predicted outputs of the ML model using a highest-probability approach or a thresholding approach (e.g., based on the model predicted score 118).

For example, in example process 300 illustrated in FIG. 3, a recommender system is trained to generate recommendations of electronic products that may be displayed to a user online. Accordingly, at step 202 in FIG. 2, this recommender system processes user-specific data 302 (e.g., similar to user-specific data 112 in FIG. 1) for a user, via a model 304 (e.g., similar to model 108 in FIG. 1), and thereby generates four possible predicted outputs (e.g., possible recommendations that may be used as model output) for model 304. User-specific data 302 may include information about other products displayed online that the user frequently and/or has recently interacted with. A first possible recommendation may be a personalized recommendation to display a printer to the user (e.g., printer recommendation 306). A second possible recommendation may be a personalized recommendation to display a camera to the user (e.g., camera recommendation 308). A third possible recommendation may be a personalized recommendation to display a projector to the user (e.g., projector recommendation 310). Further, a fourth possible recommendation may be a personalized recommendation to display a cell phone to the user (e.g., cell phone recommendation 312).

Model 304 in FIG. 3 may also generate a model predicted score 314 for each of the four prediction outputs. A model predicted score 314 generated by model 304 for a possible recommendation of model 304 may indicate a probability of the effectiveness of the possible recommendation for a user (e.g., a user associated with user-specific data 302). A first model predicted score 314(1) generated for printer recommendation 306 is a 90% probability, a second model predicted score 314(2) generated for camera recommendation 308 is a 70% probability, a third model predicted score 314(3) generated for projector recommendation 310 is a 65% probability, and a fourth model predicted score 314(4) generated for cell phone recommendation 312 is a 78% probability.

After each possible recommendation is generated by model 304, as well as a model predicted score 314 for each possible recommendation, a narrowing technique 316 may be applied to narrow the prediction outputs down to a “best” prediction output for the user. A “best” prediction output may be determined, for example, using a highest-probability approach and/or a thresholding approach. Assuming highest-probability techniques are used in this example, then the “best” prediction output is determined to be printer recommendation 306. As such, model output 318 (e.g., similar to model output 116 in FIG. 1) is printer recommendation 306.

Returning to FIG. 2, method 200 then proceeds, to step 204, with calculating a SHAP score (e.g., similar to SHAP score 120 in FIG. 1) based on the model output, the model predicted score, and the user-specific data. As described above, the SHAP score calculated for the model output may be equal to the absolute value of a difference between the model predicted score associated with the model output(f(x)) and a base SHAP value for the model output (E[f(x)]) (e.g., |f(x)−E[f(x)]|).

For example, in FIG. 3, at step 204, the recommender system calculates a SHAP score 324 for model output 318 (e.g., printer recommendation 306) as 0.01.

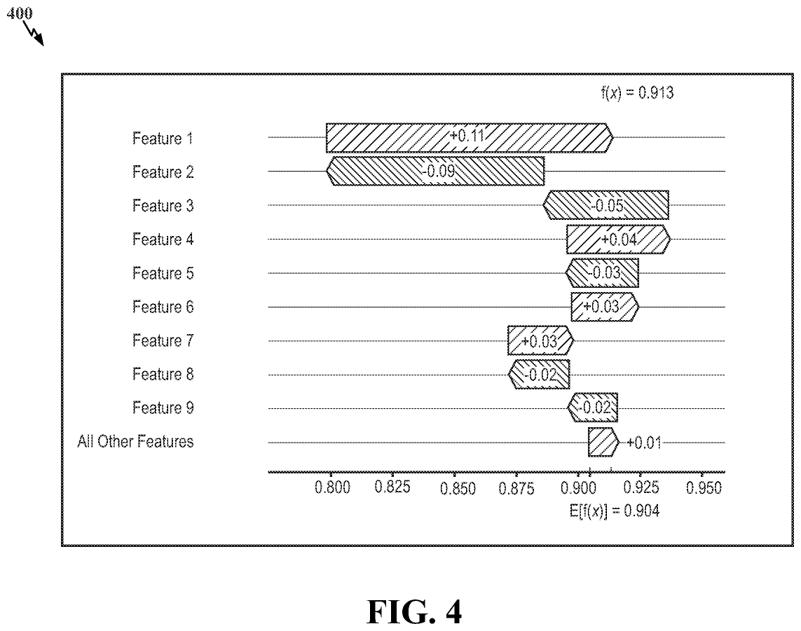

FIG. 4 illustrates the relationship 400 between SHAP score 334 calculated for printer recommendation 306, model predicted score 314 for model output 318, and a base SHAP value for model output 318 in FIG. 3. As illustrated, user-specific data 302 provided to model 304 in FIG. 3 may include at least values for nine different input features for model 304 (e.g., illustrated as Features 1-9). In some cases, the values for one or more of the nine input features are equal to “0” where data for the corresponding input feature is not available, missing, or unknown.

Model predicted score 314, f(x), may be calculated for model output 318 based on a contribution of each input feature value included in the input vector in predicting model output 318. A model predicted score 314 generated for printer recommendation 306 (e.g., by model 304) is f(x)=0.913.

In particular, as illustrated, a value defined for Features 1, 4, 6, and 7 positively and/or significantly contributes to (e.g., have a greater impact on) model 304 predicting that a printer is to be displayed to the user (e.g., the printer recommendation 306). Accordingly, a SHAP value individually determined for each of Feature 1, Feature 4, Feature 6, and Feature 7 is a positive value. Values for other features defined in user-specific data 302 may also have an almost negligent, yet positive impact on the final f(x) score calculated for printer recommendation 306.

However, a value defined for Features 2, 3, 5, 8, and 9 minimally contribute to (e.g., have a lesser impact on) model 304 predicting that a printer is to be displayed to the user (e.g., predicting the printer recommendation 306). Accordingly, a SHAP value individually determined for each of Feature 2, Feature 3, Feature 5, Feature 8, and Feature 9 is a negative value.

The sum of these ten SHAP values may represent the first model predicted score 314(1), f(x), or first model predicted score 314(1) generated by model 304 for printer recommendation 306.

Additionally, as shown in FIG. 4, a base SHAP value for model output 318 may be calculated as E[f(x)]=0.904. Again, the base SHAP value for model output 318 represents an average model predicted score across an entire observed training dataset for model output 318.

The absolute value difference between first model predicted score 314(1),f(x)=0.913, and the base SHAP value for model output 318, E[f(x)]=0.904, is equal to SHAP score 324 calculated for model output 318 (e.g., |f(x)−E[f(x)]|=|0.913)−0.904| 0.01).

Method 200 then proceeds, to step 206, with providing the model output from the ML model or generic output as output based on the SHAP score (e.g., calculated at step 204). In some embodiments, step 206 includes steps 208-212. For example, to provide the model output or the generic output based on the SHAP score, at step 208, the recommender system determines if the SHAP score is (1) greater than or equal to a threshold value (e.g., threshold value 124 in FIG. 1) or (2) less than the threshold value. If the SHAP score is equal to or greater than the threshold value, then at step 210, the model output is provided as output from the ML model (e.g., in other words, an effective personalized recommendation is provided). Alternatively, if the SHAP score is less than the threshold value, then at step 212, generic output is provided as output (e.g., in other words, a non-personalized recommendation is provided instead of an ineffective personalized recommendation).

For example, in FIG. 3, at step 206, the recommender system determines to provide model output 318 or generic output as output (e.g., based on user-specific data 302 provided to model 304). To make this determination, the recommender system compares SHAP score 324=0.01 to a threshold value 326 (e.g., similar to threshold value 124 in FIG. 1) equal to 0.008. Because SHAP score 324 is greater than the threshold value 326 (e.g., 0.01>0.008), model output 318 is determined to be an effective personalized recommendation 328. As such, model output 318 is provided to the user.

Although not shown, in other embodiments where SHAP score 324 is less than threshold value 326, then model output 318 would be determined to be an ineffective personalized recommendation. As such, a generic recommendation may be provided to the user instead of the ineffective personalized recommendation. By providing the generic recommendation instead of the ineffective personalized recommendation, providing an ineffective recommendation may be avoided.

In some embodiments, after classifying the model output as an effective personalized recommendation and thus providing the model output as output to the user, such as after step 210 in FIG. 2, interaction between the user and the personalized recommendation may be monitored. For example, the recommender system may determine if the user clicks on, views, opens, listens to, searches for, etc. an object associated with the model output. This feedback may help to determine whether the model output is indeed an effective recommendation. Minimal or no interaction with the model output (e.g., no interaction with a printer icon recommended to the displayed by the system) may indicate that the system incorrectly predicted the effectiveness of this model output. Further, in some embodiments, the system may receive feedback on the effectiveness of the model output. Negative feedback may also indicate that the system incorrectly predicted the effectiveness of this model output. Based on this user feedback and/or interaction feedback gathered by the system, additional steps may be performed to adjust one or more parameters of the model that provided the model output (e.g., the ineffective personalized recommendation).

For example, after determining that the SHAP score associated with the model output is above the threshold value thereby making the model output an effective personalized recommendation and obtaining negative feedback that indicates otherwise (e.g., that the model is actually an ineffective personalized recommendation), a training data instance may be created. The training data instance may include a training input comprising the input data processed by the model (e.g., processed at step 202) and a training output comprising the model output and an indication that the model output is associated with negative feedback. This training instance may be used to further train the model to adjust one or more parameters of the model. In other words, this training data instance may be used to train the model not to generate this model output (e.g., make this recommendation) when the input data is received by the model. As such, performance of the model in generating effective recommendations may be improved.

Alternatively, in some embodiments, positive feedback may be obtained for the model output provided to the user. As such, a training data instance may be created, where the training data instance includes a training input comprising the input data processed by the model (e.g., processed at step 202) and a training output comprising the model output and an indication that the model output is associated with positive feedback. This training instance may also be used to further train the model to adjust one or more parameters of the model.

### Example Results Using the Method for Selecting Between a Model Output and a Generic Output

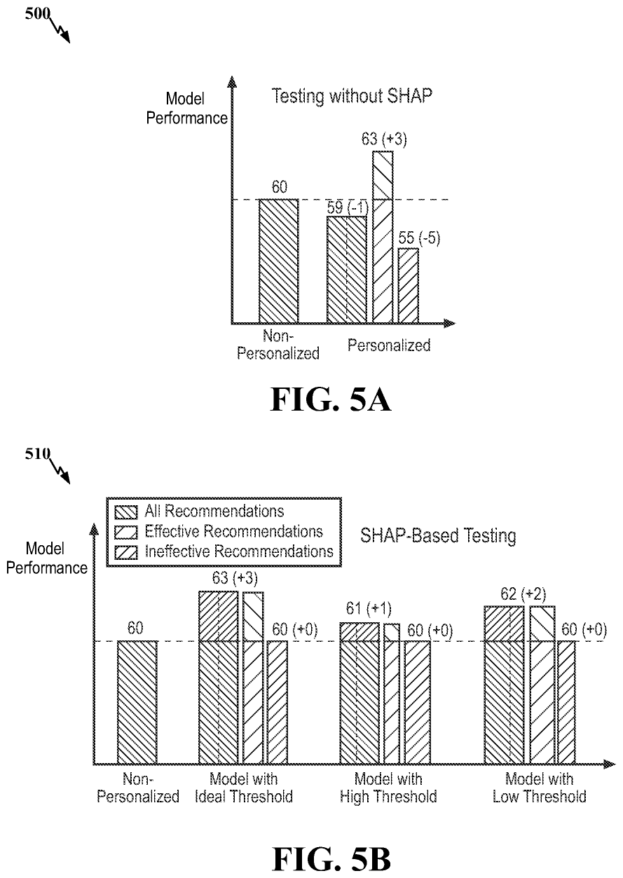

FIGS. 5A and 5B together illustrate improved model performance when method 200 in FIG. 2 is used to select between a model output (e.g., a personalized recommendation) and a generic output (e.g., a non-personalized recommendation).

In FIG. 5A, a first model performance graph 500 is provided to compare model performance for a non-personalized recommendation model with a personalized recommendation model deployed in a recommender system, such as system 100 of FIG. 1. The personalised recommendation model in this case does not use SHAP values to determine the effectiveness of a predicted personalized recommendation before it is provided to a user. Instead, all personalized recommendations predicted by the personalized recommendation model are provided as model output. As is shown in first model performance graph 500, providing all personalized recommendations without first understanding the effectiveness of each of the personalized recommendations may actually decrease model performance below that of the non-personalized recommendation model. For example, model performance for the non-personalized recommendation model is equal to 60% while model performance for the personalized recommendation model is equal to 59%, or a 1% lower model performance than the non-personalized recommendation model. The model performance of the personalized recommendation model is calculated to be 59% based on the model performance being 63% when only effective personalized recommendations are provided and the model performance being 55% when only non-effective personalized recommendations are provided (e.g., (63%+55%)/2=59%).

A second model performance graph 510 illustrated in FIG. 5B is provided to also compare model performance for a non-personalized recommendation model with a personalized recommendation model deployed in a recommender system. However, the personalized recommendation model in this case does use SHAP values to determine the effectiveness of a predicted personalized recommendation before it is provided to a user. In particular, method 200 illustrated in FIG. 2 is used to determine the effectiveness score of a personalized recommendation generated by the personalized recommendation model, and this effectiveness score is further used to select between providing the personalized recommendation or a non-personalized recommendation to a user. As is shown in second model performance graph 510, a personalized recommendation model that has an ideal threshold for determining the effectiveness of a generated personalized recommendation to decide whether the personalised recommendation should be provided as output has a model performance of 63% (e.g., 3% greater than the model performance of the non-personalized recommendation model). Second model performance graph 510 also illustrates the model performance of a personalized recommendation model that has a high threshold and the model performance of a personalized recommendation model that has a high threshold.

A personalized recommendation model that has a high threshold may identify less personalized recommendations generated by the model as effective compared to the model with the ideal threshold. As such, the model performance (e.g., for the model with the high threshold) with respect to providing effective personalized recommendations (61%) is lower than that for the model with the ideal threshold (63%) in this example; however, overall model performance (61%) is still greater than the model performance of the non-personalized recommendation model (e.g., 1% greater than the model performance of the non-personalized recommendation model) in this example.

A personalized recommendation model that has a low threshold may identify more personalized recommendations generated by the model as effective compared to the model with the ideal threshold. As such, the model performance (e.g., for the model with the high threshold) with respect to providing effective personalized recommendations (62%) is lower than that for the model with the ideal threshold (63%) in this example; however, overall model performance (62%) is still greater than the model performance of the non-personalized recommendation model (e.g., 2% greater than the model performance of the non-personalized recommendation model) in this example.

Personalized recommendation models that determine the effectiveness of personalized recommendations generated by the model may provide generic output (e.g., non-personalized recommendations) when the personalized recommendations are determined to be ineffective (instead of the ineffective personalized recommendation). Providing generic output may not have any effect on model performance, as such, the model performance for each personalized recommendation model with different thresholds, illustrated in second model performance graph 500, may be consistent for ineffective personalized recommendations (60% for all).

It is noted that the results illustrated in FIG. 5B are just one example of improved results that may be achieved with one model and with one input data set, and other results for other models and/or other input data sets may be realized. Generally, the results illustrated in FIG. 5B show that performance using SHAP-based thresholding is better than conventional models, whether personalized or non-personalized.

### Example Processing System for Using SHAP Values to Select Between Providing a Personalized Recommendation or a Generic Recommendation

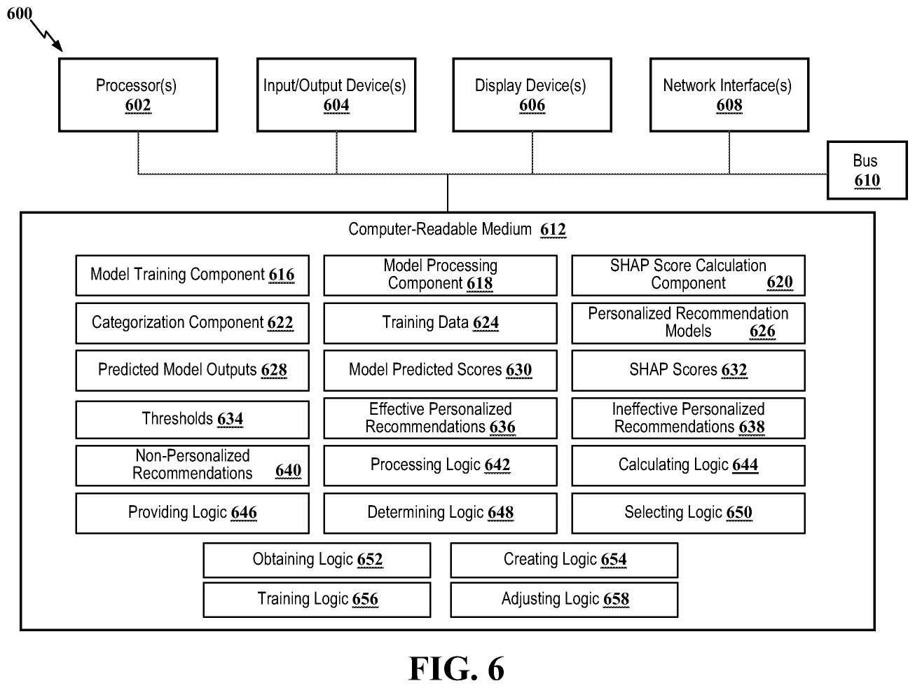

FIG. 6 depicts an example processing system 600 configured to perform various aspects described herein, including, for example, steps in method 200 as described above with respect to FIG. 2 and the example described with respect to FIG. 3.

Processing system 600 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 600 includes one or more processors 602, one or more input/output devices 604, one or more display devices 606, and one or more network interfaces 608 through which processing system 600 is connected to one or more networks (e.g., a local network, an intranet, the Internet, or any other group of processing systems communicatively connected to each other), and computer-readable medium 612.

In the depicted example, the aforementioned components are coupled by a bus 610, which may generally be configured for data and/or power exchange amongst the components. Bus 610 may be representative of multiple buses, while only one is depicted for simplicity.

Processor(s) 602 are generally configured to retrieve and execute instructions stored in one or more memories, including local memories like the computer-readable medium 612, as well as remote memories and data stores. Similarly, processor(s) 602 are configured to retrieve and store application data residing in local memories like the computer-readable medium 612, as well as remote memories and data stores. More generally, bus 610 is configured to transmit programming instructions and application data among the processor(s) 602, display device(s) 706, network interface(s) 608, and computer-readable medium 612. In certain embodiments, processor(s) 602 are included to be representative of a one or more central processing units (CPUs), graphics processing unit (GPUs), tensor processing unit (TPUs), accelerators, and other processing devices.

Input/output device(s) 604 may include any device, mechanism, system, interactive display, and/or various other hardware components for communicating information between processing system 600 and a user of processing system 600. For example, input/output device(s) 604 may include input hardware, such as a keyboard, touch screen, button, microphone, and/or other device for receiving inputs from the user. Input/output device(s) 604 may further include display hardware, such as, for example, a monitor, a video card, and/or other another device for sending and/or presenting visual data to the user. In certain embodiments, input/output device(s) 704 is or includes a graphical user interface.

Display device(s) 606 may generally include any sort of device configured to display data, information, graphics, user interface elements, and the like to a user. For example, display device(s) 606 may include internal and external displays such as an internal display of a tablet computer or an external display for a server computer or a projector. Display device(s) 606 may further include displays for devices, such as augmented, virtual, and/or extended reality devices.

Network interface(s) 608 provide processing system 600 with access to external networks and thereby to external processing systems. Network interface(s) 608 can generally be any device capable of transmitting and/or receiving data via a wired or wireless network connection. Accordingly, network interface(s) 608 can include a communication transceiver for sending and/or receiving any wired and/or wireless communication. For example, Network interface(s) 608 may include an antenna, a modem, a LAN port, a Wi-Fi card, a WiMAX card, cellular communications hardware, near-field communication (NFC) hardware, satellite communication hardware, and/or any wired or wireless hardware for communicating with other networks and/or devices/systems. In certain embodiments, network interface(s) 708 includes hardware configured to operate in accordance with the Bluetooth® wireless communication protocol.

Computer-readable medium 612 may be a volatile memory, such as a random access memory (RAM), or a nonvolatile memory, such as nonvolatile random access memory, phase change random access memory, or the like. In this example, computer-readable medium 612 includes model training component 616, model processing component 618, SHAP score calculation component 620, categorization component 622, training data 624, personalized recommendation models 626, predicted model outputs 628, model predicted scores 630, SHAP scores 632, thresholds 634, effective personalized recommendations 636, ineffective personalized recommendations 638, non-personalized recommendations 640, processing logic 642, calculating logic 644, providing logic 646, determining logic 648, selecting logic 650, obtaining logic 652, creating logic 654, training logic 656, and adjusting logic 658.

In some embodiments, processing logic 642 includes logic for processing user-specific data with the ML model to generate the model output and a model predicted score associated with the model output.

In some embodiments, calculating logic 644 includes logic for calculating a SHAP score based on the model output and the user-specific data. In some embodiments, calculating logic 644 includes logic for calculating a sum of the SHAP values determined for the one or more input features in the user-specific data, wherein the SHAP score comprises the sum.

In some embodiments, providing logic 646 includes logic for providing the model output or the generic output as output from the ML model based on the SHAP score. In some embodiments, providing logic 646 includes logic for providing the model output as the output from the ML model if the SHAP score is equal to or greater than a threshold value. In some embodiments, providing logic 646 includes logic for providing the generic output as the output from the ML model if the SHAP score is less than a threshold value. In some embodiments, providing logic 646 includes logic for providing the model output as output from the ML model based on the SHAP score being equal to or above the threshold value.

In some embodiments, determining logic 648 includes logic for determining a SHAP value for each input feature in the user-specific data used to generate the model output and the model predicted score, wherein the user-specific data comprises one or more input features. In some embodiments, determining logic 648 includes logic for determining the SHAP score associated with the model output is equal to or above a threshold value.

In some embodiments, selecting logic 650 includes logic for selecting a model output based on a model prediction score associated with the model output.

In some embodiments, obtaining logic 652 includes logic for obtaining negative feedback indicating that the model output is an ineffective recommendation.

In some embodiments, creating logic 654 includes logic for creating a training data instance comprising: a training input comprising the user-specific data; and a training output comprising the model output and an indication that the model output is associated with negative feedback.

In some embodiments, training logic 656 includes logic for training and/or re-training a machine learning model to generate personalized recommendations for various users.

In some embodiments, adjusting (or modifying) logic 658 includes logic for modifying the threshold value based on user feedback. In some embodiments, training logic 656 includes logic for adjusting one or more parameters of the ML model based on a training data instance including a training input comprising user-specific data and a training output comprising a model output and an indication that the model output is associated with negative feedback.

Note that FIG. 6 is just one example of a processing system consistent with aspects described herein, and other processing systems having additional, alternative, or fewer components are possible consistent with this disclosure.

### Example Clauses

Implementation details of various aspects of the present disclosure are described in the following numbered clauses.

Clause 1: A method for selecting between a model output of a machine learning (ML) model and a generic output, comprising: processing user-specific data with the ML model to generate the model output and a model predicted score associated with the model output; calculating a Shapley Additive Explanations (SHAP) score based on the model output and the user-specific data; and providing the model output or the generic output as output from the ML model based on the SHAP score.

Clause 2: The method of Clause 1, wherein providing the model output or the generic output as the output from the ML model based on the SHAP score comprises: providing the model output as the output from the ML model if the SHAP score is equal to or greater than a threshold value; and providing the generic output as the output from the ML model if the SHAP score is less than a threshold value.

Clause 3: The method of Clause 2, further comprising modifying the threshold value based on user feedback.

Clause 4: The method of any one of Clauses 2-3, wherein: the ML model and the threshold value are personalized for a user, and the model output or the generic output is provided to the user.

Clause 5: The method of any one of Clauses 2-4, wherein the generic output is generated based on generic input data comprising: null or zero values, or random values.

Clause 6: The method of any one of Clauses 1-5, wherein calculating the SHAP score based on the model output and the user-specific data comprises: determining a SHAP value for each input feature in the user-specific data used to generate the model output and the model predicted score, wherein the user-specific data comprises one or more input features; and calculating a sum of the SHAP values determined for the one or more input features in the user-specific data, wherein the SHAP score comprises the sum.

Clause 7: The method of any one of Clauses 1-6, wherein the model output generated by the ML model comprises a predicted output among a set of possible predicted outputs of the ML model determined using a highest-probability approach or a thresholding approach.

Clause 8: The method of Clause 7, wherein the model predicted score comprises: a probability of the model output being an effective recommendation for a user, an odds statistic indicating the probability of the model output being the effective recommendation for the user and a probability of the model output being an ineffective recommendation for the user, or a log odds statistic calculated by taking a logarithm of the odds statistic for the corresponding predicted output.

Clause 9: A method for training a machine learning (ML) model to generate effective model output, comprising: processing user-specific data with the ML model to generate a model output and a model predicted score associated with the model output; calculating a Shapley Additive Explanations (SHAP) score based on the model output and the user-specific data; determining the SHAP score associated with the model output is equal to or above a threshold value; providing the model output as output from the ML model based on the SHAP score being equal to or above the threshold value; obtaining negative feedback indicating that the model output is an ineffective recommendation; creating a training data instance comprising: a training input comprising the user-specific data; and a training output comprising the model output and an indication that the model output is associated with the negative feedback; and adjusting one or more parameters of the ML model based on the training data instance.

Clause 10: The method of Clause 9, wherein calculating the SHAP score based on the model output and the user-specific data comprises: determining a SHAP value for each input feature in the user-specific data used to generate the model output and the model predicted score, wherein the user-specific data comprises one or more input features; and calculating a sum of the SHAP values determined for the one or more input features in the user-specific data, wherein the SHAP score comprises the sum.

Clause 11: The method of any one of Clauses 9-10, wherein the model output generated by the ML model comprises a predicted output among a set of possible predicted outputs of the ML model determined using a highest-probability approach or a thresholding approach.

Clause 12: The method of Clause 11, wherein the model predicted score comprises: a probability of the model output being an effective recommendation for a user, an odds statistic indicating the probability of the model output being the effective recommendation for the user and a probability of the model output being an ineffective recommendation for the user, or a log odds statistic calculated by taking a logarithm of the odds statistic for the corresponding predicted output.

Clause 13: A processing system, comprising: a memory comprising computer-executable instructions; and a processor configured to execute the computer-executable instructions and cause the processing system to perform a method in accordance with any one of Clauses 1-12.

Clause 14: A processing system, comprising means for performing a method in accordance with any one of Clauses 1-12.

Clause 15: A non-transitory computer-readable medium storing program code for causing a processing system to perform the steps of any one of Clauses 1-12.

Clause 16: A computer program product embodied on a computer-readable storage medium comprising code for performing a method in accordance with any one of Clauses 1-12.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various steps of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are steps illustrated in figures, those steps may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for selecting between a model output of a machine learning (ML) model and a generic output, comprising:
processing user-specific data with the ML model to generate the model output and a model predicted score associated with the model output;
calculating a Shapley Additive Explanations (SHAP) score based on the model output, the model predicted score, and the user-specific data; and
providing the model output or the generic output as output from the ML model based on the SHAP score.

2. The method of claim 1, wherein providing the model output or the generic output as the output from the ML model based on the SHAP score comprises:
providing the model output as the output from the ML model if the SHAP score is equal to or greater than a threshold value; and
providing the generic output as the output from the ML model if the SHAP score is less than a threshold value.

3. The method of claim 2, further comprising modifying the threshold value based on user feedback.

4. The method of claim 2, wherein:
the ML model and the threshold value are personalized for a user, and
the model output or the generic output is provided to the user.

5. The method of claim 2, wherein the generic output is generated based on generic input data associated with a plurality of users.

6. The method of claim 1, wherein calculating the SHAP score based on the model output, the model predicted score, and the user-specific data comprises:
determining a SHAP value for each input feature in the user-specific data used to generate the model output and the model predicted score, wherein the user-specific data comprises one or more input features; and
calculating a sum of the SHAP values determined for the one or more input features in the user-specific data, wherein the SHAP score comprises the sum.

7. The method of claim 1, wherein the model output generated by the ML model comprises a predicted output among a set of possible predicted outputs of the ML model determined using a highest-probability approach or a thresholding approach.

8. The method of claim 7, wherein the model predicted score comprises:
a probability of the model output being an effective recommendation for a user,
an odds statistic indicating the probability of the model output being the effective recommendation for the user and a probability of the model output being an ineffective recommendation for the user, or
a log odds statistic calculated by taking a logarithm of the odds statistic for the corresponding predicted output.

9. A method for training a machine learning (ML) model to generate effective model output, comprising:
processing user-specific data with the ML model to generate a model output and a model predicted score associated with the model output;
calculating a Shapley Additive Explanations (SHAP) score based on the model output, the model predicted score, and the user-specific data;
determining the SHAP score associated with the model output is equal to or above a threshold value;
providing the model output as output from the ML model based on the SHAP score being equal to or above the threshold value;
obtaining negative feedback indicating that the model output is an ineffective recommendation;
creating a training data instance comprising:
a training input comprising the user-specific data; and
a training output comprising the model output and an indication that the model output is associated with the negative feedback; and
adjusting one or more parameters of the ML model based on the training data instance.

10. The method of claim 9, wherein calculating the SHAP score based on the model output, the model predicted score, and the user-specific data comprises:
determining a SHAP value for each input feature in the user-specific data used to generate the model output and the model predicted score, wherein the user-specific data comprises one or more input features; and
calculating a sum of the SHAP values determined for the one or more input features in the user-specific data, wherein the SHAP score comprises the sum.

11. The method of claim 9, wherein the model output generated by the ML model comprises a predicted output among a set of possible predicted outputs of the ML model determined using a highest-probability approach or a thresholding approach.

12. The method of claim 11, wherein the model predicted score comprises:
a probability of the model output being an effective recommendation for a user,
an odds statistic indicating the probability of the model output being the effective recommendation for the user and a probability of the model output being an ineffective recommendation for the user, or
a log odds statistic calculated by taking a logarithm of the odds statistic for the corresponding predicted output.

13. A processing system, comprising:
a memory comprising computer-executable instructions; and
a processor configured to execute the computer-executable instructions and cause the processing system to:
process user-specific data with a machine learning (ML) model to generate the model output and a model predicted score associated with the model output;
calculate a Shapley Additive Explanations (SHAP) score based on the model output, the model predicted score, and the user-specific data; and
provide the model output or the generic output as output from the ML model based on the SHAP score.

14. The processing system of claim 13, wherein to provide the model output or the generic output as the output from the ML model based on the SHAP score, the processor is configured to cause the processing system to:
provide the model output as the output from the ML model if the SHAP score is equal to or greater than a threshold value; and
provide generic output as the output from the ML model if the SHAP score is less than a threshold value.

15. The processing system of claim 14, wherein the processor is further configured to cause the processing system to modify the threshold value based on user feedback.

16. The processing system of claim 14, wherein:
the ML model and the threshold value are personalized for a user, and
the model output or the generic output is provided to the user.

17. The processing system of claim 14, wherein the generic output is generated based on generic input data associated with a plurality of users.

18. The processing system of claim 13, wherein to calculate the SHAP score based on the model output, the model predicted score, and the user-specific data, the processor is configured to cause the processing system to:
determine a SHAP value for each input feature in the user-specific data used to generate the model output and the model predicted score, wherein the user-specific data comprises one or more input features; and
calculate a sum of the SHAP values determined for the one or more input features in the user-specific data, wherein the SHAP score comprises the sum.

19. The processing system of claim 13, wherein the model output generated by the ML model comprises a predicted output among a set of possible predicted outputs of the ML model determined using a highest-probability approach or a thresholding approach.

20. The processing system of claim 19, wherein the model predicted score comprises:
a probability of the model output being an effective recommendation for a user,
an odds statistic indicating the probability of the model output being the effective recommendation for the user and a probability of the model output being an ineffective recommendation for the user, or
a log odds statistic calculated by taking a logarithm of the odds statistic for the corresponding predicted output.
